(19) United States
(12) Patent Application Publication
(10) Pub. No.: US 2024/0213596 A1
(43) Pub. Date: Jun. 27, 2024

(54) MANUFACTURING METHOD FOR POWER STORAGE DEVICE, AND POWER STORAGE DEVICE

(71) Applicant: Prime Planet Energy & Solutions, Inc., Tokyo (JP)

(72) Inventor: Katsuya SHIKATA, Nisshin-shi (JP)

(21) Appl. No.: 18/496,927

(22) Filed: Oct. 30, 2023

(30) Foreign Application Priority Data
Dec. 22, 2022 (JP) 2022-205849

(51) Int. Cl. H01M 50/169; H01M 10/04; H01M 50/103; H01M 50/119; H01M 50/159

(52) U.S. Cl. CPC H01M 50/169; H01M 10/049; H01M 50/103; H01M 50/119; H01M 50/159

(57) ABSTRACT

The present disclosure provides a manufacturing method for a power storage device including a case main body, a sealing plate, an electrode body, and a film body with an insulating property. The film body includes a long side surface, and a bent part extending from the long side surface toward the sealing plate and bent so as to get close to the electrode body. A light diffusion part that diffuses laser light is provided to the bent part. This manufacturing method includes a preparing step of preparing the film body, an accommodating step of accommodating the electrode body and the film body in the case main body, and a laser welding step of welding an outer peripheral part of the sealing plate to an inner peripheral part of an opening of the case main body by laser.

### CROSS REFERENCE TO RELATED APPLICATION

This application claims the benefit of priority to Japanese Patent Application No. 2022-205849 filed on Dec. 22, 2022. The entire contents of this application are hereby incorporated herein by reference.

### BACKGROUND OF THE DISCLOSURE

### 1. Field

The present disclosure relates to a manufacturing method for a power storage device, and the power storage device.

### 2. Background

Conventionally, a power storage device including a case main body with an opening, a sealing plate (lid body) that seals the opening of the case main body, and an electrode body that is accommodated in the case main body has been known. This type of power storage device is manufactured in a manner that, for example, the electrode body is accommodated inside the case main body through the opening, the sealing plate is disposed inside the opening of the case main body, and then, an inner peripheral part of the opening of the case main body and an outer peripheral part of the sealing plate are welded to each other by laser. Conventional technical literatures related to this include Japanese Patent Application Publication No. 2020-095836, Japanese Patent Application Publication No. 2014-29823, Japanese Patent Application Publication No. 2019-110036, and Japanese Patent Application Publication No. 2016-91716.

For example, Japanese Patent Application Publication No. 2020-095836 discloses a structure in which a box-shaped insulation film (film body) is disposed between a case main body and an electrode body and an inclined surface that is inclined toward the electrode body is formed at an end part of the film body on a sealing plate side. According to Japanese Patent Application Publication No. 2020-095836, even if a metal foreign substance gets mixed in the case main body at the time of laser welding or the like, such a structure can suppress the entry of the mixed metal foreign substance into the electrode body by trapping the mixed metal foreign substance outside the film body.

### SUMMARY

According to the present inventor's examination, a space of about several tens of micrometers may be formed between the opening of the case main body and the sealing plate due to a machining error or the like. Therefore, at the laser welding, laser light may enter the case main body through this space, that is, so-called laser passing may occur. Since the laser light is superior in a straight traveling property and a light condensing property, the fall of the laser light having entered the case main body on the film body may melt the film body due to heat of the laser light. Furthermore, the fall of the laser light on the electrode body may scorch the electrode body or cause internal short-circuiting.

The present disclosure has been made in view of the above circumstances, and an object is to provide a manufacturing method for a power storage device, and the power storage device, in which an electrode body is not damaged easily even in the occurrence of laser passing.

The present disclosure provides a manufacturing method for a power storage device including: a case main body made of metal and including a bottom wall with a rectangular shape, a pair of long side walls extending from long sides of the bottom wall and facing each other, a pair of short side walls extending from short sides of the bottom wall and facing each other, and an opening facing the bottom wall; a sealing plate made of metal, disposed in the opening of the case main body, and having an outer peripheral part thereof welded by laser to an inner peripheral part of the opening of the case main body; an electrode body accommodated in the case main body and including a pair of wide surfaces facing the long side walls; and a film body with an insulating property that exists between the electrode body and the case main body, in which the film body includes a pair of long side surfaces existing between the pair of long side walls of the case main body and the pair of wide surfaces of the electrode body and extending along the long side walls, and bent parts extending from the pair of long side surfaces toward the sealing plate and bent so as to get close to the electrode body, and a light diffusion part that diffuses laser light is provided to at least the bent part. This manufacturing method includes a preparing step of preparing the film body, an accommodating step of accommodating the electrode body and the film body in the case main body, and a laser welding step of disposing the sealing plate in the opening of the case main body and welding the outer peripheral part of the sealing plate to the case main body by laser.

In the manufacturing method, the light diffusion part is provided to the bent part of the film body. Thus, even if laser passing occurs at laser welding to cause the laser light to enter the case main body through the space between the case main body and the sealing plate, the laser light can be diffused by the light diffusion part and the beam density of the laser light can be reduced. As a result, the melting of the film body with the heat of the laser light becomes difficult. Accordingly, the laser light does not fall on the electrode body easily and the scorching of the electrode body or the internal short-circuiting can be suppressed.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating a power storage device according to an embodiment;

FIG. 2 is a schematic longitudinal cross-sectional view taken along line II-II in FIG. 1;

FIG. 3 is a schematic longitudinal cross-sectional view taken along line III-III in FIG. 1;

FIG. 4 is a perspective view schematically illustrating a film body according to the embodiment; and

FIG. 5 is a schematic view of an insulation film that forms the film body in FIG. 4.

### DETAILED DESCRIPTION OF THE PREFERRED EMBODIMENTS

Hereinafter, some preferred embodiments of the art disclosed herein will be described with reference to the drawings. Incidentally, matters other than matters particularly mentioned in the present specification, and necessary for the implementation of the art disclosed herein (for example, the general configuration and manufacturing process of a power storage device that do not characterize the art disclosed herein) can be grasped as design matters of those skilled in the art based on the conventional art in the relevant field. The art disclosed herein can be implemented on the basis of the disclosure of the present specification and common technical knowledge in the relevant field. In the present specification, the notation “A to B” for a range signifies “a value more than or equal to A and less than or equal to B”, and is meant to encompass also the meaning of being “more than A” and “less than B”.

### Power Storage Device

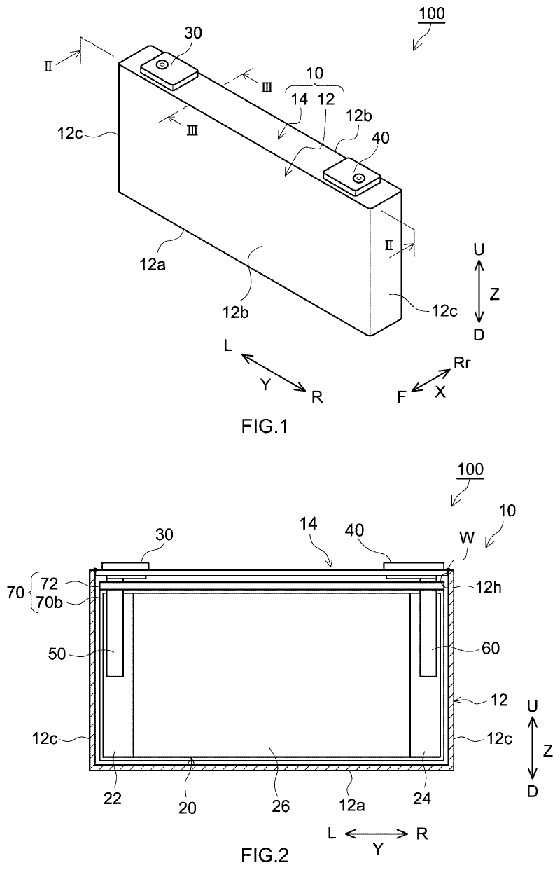

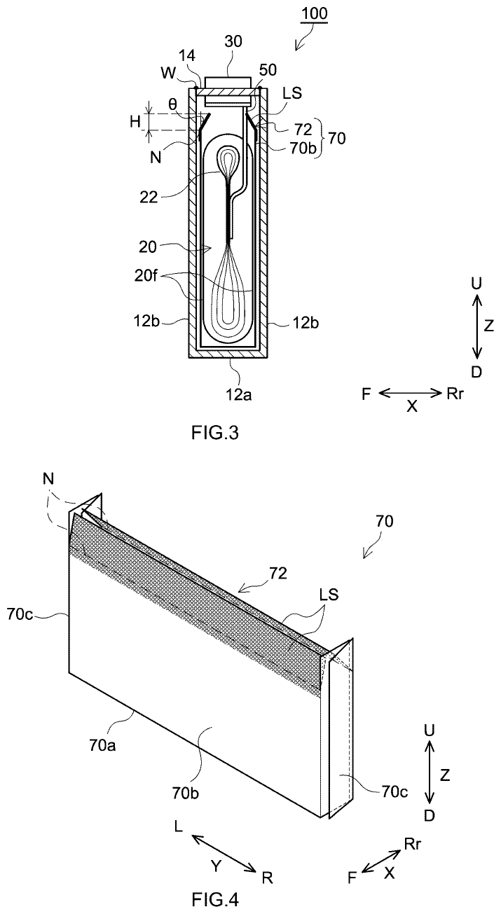

FIG. 1 is a schematic perspective view of a power storage device 100. FIG. 2 is a schematic longitudinal cross-sectional view taken along line II-II in FIG. 1. FIG. 3 is a schematic longitudinal cross-sectional view taken along line III-III in FIG. 1. In the following description, reference signs L, R, F, Rr, U, and D in the drawings respectively denote left, right, front, rear, up, and down. In addition, a reference sign X in the drawings denotes a short side direction (thickness direction) of the power storage device 100, a reference sign Y denotes a long side direction that is orthogonal to the short side direction, and a reference sign Z denotes a height direction of the power storage device 100. These directions are defined however for convenience of explanation, and do not limit the manner in which the power storage device 100 is disposed.

For example, the power storage device 100 may be a secondary battery such as a lithium ion secondary battery or a nickel-hydrogen battery, or may be a lithium ion capacitor, an electrical double-layer capacitor, or the like. Here, the power storage device 100 is a secondary battery, specifically a lithium ion secondary battery.

As illustrated in FIG. 2, the power storage device 100 includes a battery case 10, an electrode body 20 (also see FIG. 3), and a film body 70. Although not illustrated, the power storage device 100 in this case further includes a nonaqueous electrolyte solution. The nonaqueous electrolyte solution may be any nonaqueous electrolyte solution used in general nonaqueous electrolyte secondary batteries (for example, lithium ion secondary batteries), without particular limitations. In another embodiment, however, an electrolyte may have a solid form (a solid electrolyte) to be integrated with the electrode body 20.

The battery case 10 is a housing that accommodates the electrode body 20 and the nonaqueous electrolyte solution. As illustrated in FIG. 1, the external shape of the battery case 10 here is a flat and bottomed cuboid shape (rectangular shape). A conventionally used material can be used for the battery case 10, without particular limitations. The battery case 10 is made of a metal, and for example, preferably made of aluminum, an aluminum alloy, iron, an iron alloy, or the like. As illustrated in FIG. 2, the battery case 10 includes a case main body 12 and a sealing plate (lid body) 14.

The case main body 12 is a bottomed and rectangular cylindrical container. As illustrated in FIG. 1, the case main body 12 includes a bottom wall 12a with a rectangular shape, a pair of long side walls 12b extending from long sides of the bottom wall 12a and facing each other, a pair of short side walls 12c extending from short sides of the bottom wall 12a and facing each other, and an opening 12h (see FIG. 2) facing the bottom wall 12a. The opening 12h is rectangular in shape. The long side wall 12b is larger in area than the short side wall 12c. Note that in the present specification, “rectangular shape” is a term encompassing, in addition to a perfect rectangular shape (rectangle), for example, a shape whose corner connecting a long side and a short side of the rectangular shape is rounded, a shape whose corner includes a notch, and the like. In the following description, the opening 12h side of the case main body 12 may be referred to as “up”, and the bottom wall 12a side of the case main body 12 may be referred to as “down”.

The sealing plate 14 is a plate-shaped member that seals the opening 12h of the case main body 12. As illustrated in FIG. 2, the sealing plate 14 is disposed inside the opening 12h of the case main body 12. The sealing plate 14 faces the bottom wall 12a of the case main body 12. The sealing plate 14 is rectangular in shape. The outer shape of the sealing plate 14 is smaller than the opening 12h in a plan view. An outer peripheral part of the sealing plate 14 is welded by laser to an inner peripheral part of the opening 12h of the case main body 12 along the entire circumference. On the outer peripheral part of the sealing plate 14, a laser welding part W is formed along the entire circumference. Thus, the battery case 10 is integrated and hermetically sealed (closed). Note that in FIG. 1, the illustration of the laser welding part W is omitted.

As illustrated in FIG. 1 and FIG. 2, a positive electrode terminal 30 and a negative electrode terminal 40 are attached to the sealing plate 14. In this case, the positive electrode terminal 30 and the negative electrode terminal 40 are fixed by caulking to the sealing plate 14. The positive electrode terminal 30 and the negative electrode terminal 40 are insulated from the sealing plate 14 by an insulating member, which is not illustrated. As illustrated in FIG. 2, the positive electrode terminal 30 is electrically connected to a positive electrode of the electrode body 20 through a positive electrode current collecting member 50 inside the battery case 10. The negative electrode terminal 40 is electrically connected to a negative electrode of the electrode body 20 through a negative electrode current collecting member 60 inside the battery case 10.

As illustrated in FIG. 2, the electrode body 20 is accommodated inside the battery case 10. The electrode body 20 may be similar to the conventional electrode body, without particular limitations. Although the illustration is omitted, the electrode body 20 includes the positive electrode and the negative electrode. An outer surface of the electrode body 20 is covered with a separator 26. The electrode body 20 here is a wound electrode body with a flat shape in which the positive electrode with a band shape and the negative electrode with a band shape are stacked in an insulated state across the separator 26 with a band shape and wound in a longitudinal direction using a winding axis as a center. In another embodiment, however, the electrode body 20 may be a laminated electrode body in which a positive electrode sheet with a square shape and a negative electrode sheet with a square shape are stacked on each other in an insulated state.

The electrode body 20 is accommodated in the battery case 10 so that the winding axis is substantially parallel to the bottom wall 12a and the sealing plate 14 and is substantially orthogonal to the long side walls 12b and the short side walls 12c. Both end surfaces of the electrode body 20 in a winding axis direction (stacked surfaces where the positive electrode and the negative electrode are stacked) face the pair of short side walls 12c. As illustrated in FIG. 3, the electrode body 20 includes a pair of wide surfaces 20f whose outer surface is flat. The pair of wide surfaces 20f face the pair of long side walls 12b of the case main body 12. The wide surfaces 20f and a lower end part of the electrode body 20 are entirely covered with the film body 70 to be described below.

As illustrated in FIG. 2, a positive electrode current collecting part 22 is provided at one end part of the electrode body 20 in the winding axis direction (long side direction Y in FIG. 2). A negative electrode current collecting part 24 is provided at the other end part. The positive electrode current collecting member 50 is attached to the positive electrode current collecting part 22. The negative electrode current collecting member 60 is attached to the negative electrode current collecting part 24. The positive electrode current collecting member 50 constitutes a conductive path that electrically connects the positive electrode terminal 30 and the positive electrode of the electrode body 20. The negative electrode current collecting member 60 constitutes a conductive path that electrically connects the negative electrode terminal 40 and the negative electrode of the electrode body 20.

The film body 70 exists between the case main body 12 and the electrode body 20 inside the case main body 12. The film body 70 has an insulating property. The film body 70 is formed of a resin material with a volume resistivity of 1×10¹³ Ωcm or more, for example. The volume resistivity of the film body 70 may be, for example, 1×10¹⁵ Ωcm or more and 1×10¹⁸ Ωcm or more. The material of the film body 70 may be similar to the conventional material, without particular limitations. The material of the film body 70 is preferably, for example, a resin material such as polypropylene (PP) or polyethylene (PE). The thickness (average thickness) of the film body 70 is not limited in particular and may be 100 μm (0.1 mm) or more and is preferably 110 to 200 μm, for example.

FIG. 4 is a schematic perspective view of the film body 70. As illustrated in FIG. 4, the shape of the film body 70 is a bottomed and rectangular cylindrical shape with one surface (upper surface) open. The film body 70 is formed by, for example, bending one insulation sheet made of resin. The film body 70 includes a bottom surface 70a with a rectangular shape, a pair of long side surfaces 70b extending from long sides of the bottom surface 70a and facing each other, and a pair of short side surfaces 70c extending from short sides of the bottom surface 70a and facing each other. The bottom surface 70a is a part existing between the bottom wall 12a of the case main body 12 and the lower end part of the electrode body 20. The long side of the bottom surface 70a is shorter than the long side of the bottom wall 12a of the case main body 12.

The pair of long side surfaces 70b are parts existing between the pair of long side walls 12b of the case main body 12 and the pair of wide surfaces 20f of the electrode body 20. The pair of long side surfaces 70b extend along the long side walls 12b of the case main body 12. Between the long side surface 70b of the film body 70 and the long side wall 12b of the case main body 12, a space is preferably provided (see FIG. 3). The pair of short side surfaces 70c are parts existing between the pair of short side walls 12c of the case main body 12 and both end parts of the electrode body 20 in the winding axis direction. The pair of short side surfaces 70c extend along the short side walls 12c of the case main body 12.

At an upper end of the long side surface 70b, perforations N are provided along the long side direction Y. The perforations N are formed by half-cut processing, that is, cutting the film body 70 about to the middle of the thickness. A region above the perforations N (that is, on the sealing plate 14 side) forms a bent part 72. The perforations N constitute a border line between the long side surface 70b and the bent part 72. By the provision of the perforations N, the bent part 72 can be formed stably. However, the perforations N are not essential and in another embodiment, for example, ruled line processing for forming an assistant line (ruled line) for bending may be performed. The border between the long side surface 70b and the bent part 72 may be bent into a round shape with a predetermined radius of curvature.

The bent part 72 is bent so as to get close to the electrode body 20. In other words, the bent part 72 is bent toward a center side of the battery case 10 in the short side direction X. As illustrated in FIG. 3, here, the bent part 72 extends obliquely upward (toward the sealing plate 14) at a predetermined inclination angle θ from the long side surface 70b. The bent part 72 may have the length that does not interfere with the sealing plate 14.

Additionally, the bent part 72 may have the length that does cause the interference between the bent parts 72 facing each other in the short side direction X. A height H by which the bent part 72 extends from the long side surface 70b (length in a height direction Z in FIG. 3) may be, for example, 2 to 4 mm. The bent part 72 is preferably apart from an upper end part of the electrode body 20. The bent part 72 has a flat surface (inclined surface) here. As the bent part 72 extends toward the sealing plate 14 here, the bent part 72 is inclined so that the position of the bent part 72 goes toward the center side of the battery case 10 in the short side direction X. The bent part 72 has a substantially inverted-V shape in a cross-sectional view in FIG. 3, and the space between the bent parts 72 narrows toward the upper side (that is, toward the sealing plate 14). One surface (outer surface) of the bent part 72 faces the battery case 10 (specifically, the sealing plate 14 or the long side wall 12b) and the other surface (inner surface) thereof faces the electrode body 20.

Even if the high-temperature molten metal is generated as microparticles (so-called spattering) from the welded part at the laser welding and falls into the case main body 12, the fallen molten metal can be kept away from the electrode body 20 by the bent part 72, which will be described in detail below in the paragraph about a manufacturing method. More specifically, for example, the molten metal is trapped on the outer surface of the film body 70 or the molten metal is held between the outer surface of the film body 70 and the inner surface of the long side wall 12b, so that the harm can be eliminated. Thus, the mixing of the molten metal in the electrode body 20 to cause short-circuiting in the electrode body 20 can be suppressed.

In this embodiment, a light diffusion part (light scattering part) LS for diffusing the laser light is provided to at least the bent part 72 of the film body 70. As illustrated in FIG. 3, the light diffusion part LS is provided only on the surface (outer surface) of the film body 70 that faces the battery case 10 here. In another embodiment, however, the light diffusion part

LS may be provided only on a surface (inner surface) of the film body 70 that faces the electrode body 20 or provided on both surfaces of the film body 70.

As illustrated in FIG. 4, the light diffusion part LS is provided ranging from the bent part 72 to a part of the long side surface 70b (near the bent part 72) here. The light diffusion part LS is not provided on any of the bottom surface 70a of the film body 70, a center part to a lower end part of the long side surface 70b, and the short side surface 70c. Therefore, the bent part 72 has a relatively high light diffusion property (for example, haze value measured by a haze meter) compared with the bottom surface 70a, the center part to the lower end part of the long side surface 70b, and the short side surface 70c. In another embodiment, however, a compound material containing, for example, resin and microparticles (such as inorganic filler) with a refractive index different from that of the resin may be molded into a film shape by a conventionally known method, for example, so that the light diffusion part LS is formed on the entire film body 70.

Since the light diffusion part LS is provided to the bent part 72, even if the laser passing occurs at the laser welding to cause the laser light to enter the case main body 12 through the space between the case main body 12 and the sealing plate 14, the laser light is diffused by the light diffusion part LS with the traveling direction changed variously. Thus, the beam density of the laser light is reduced and the heat of the laser light is diffused. As a result, the melting of the film body 70 with the heat of the laser light becomes difficult. Accordingly, the laser light does not fall on the electrode body 20 easily and the scorching of the electrode body 20 or the internal short-circuiting can be suppressed. Additionally, when the bent part 72 is apart from the electrode body 20, the conduction of the heat of the laser to the electrode body 20 can be prevented at a high level.

In the evaluation of the diffusing property of transmission light, in which a laser pointer is brought into contact with the light diffusion part LS to deliver a red visible light ray (wavelength 600 nm), a diameter Φ1 (for example, Φ1=0.5 mm) of the light emitted from the laser pointer (incident light to be incident into the light diffusion part LS) is used as a reference. In this evaluation, a diameter Φ2 of the light (transmission light) having transmitted the light diffusion part LS is preferably 5 times or more and more preferably 10 times or more the diameter Φ1 of the incident light. Thus, the heat of the laser light can be diffused suitably and the heat quantity per unit area can be reduced effectively. Thus, the melting of the film body 70 can be suppressed at the high level and the fall of the laser light on the electrode body 20 can be prevented. The diameter Φ2 of the transmission light may be 20 times or less and 15 times or less the diameter Φ1 of the incident light.

The light diffusion part LS is a surface roughened part obtained by performing a roughening process on a surface of the insulation film. Note that in the present specification, “roughening process” refers to the general process for forming microscopic unevenness (texture) on the surface of the film, and includes, for example, a process of making the surface rough with sand paper, sand blast, or the like, a process of damaging the surface irregularly with a sharp blade, an embossing process of making the surface uneven with an embossing roll, a coating process of forming a layer including inorganic filler by applying a paint containing the inorganic filler and a binder on the surface, and the like. By performing the roughening process on the surface of the insulation film, the manufacture becomes easy and the manufacturing cost can be reduced compared with complicated structures disclosed in Japanese Patent Application Publication No. 2019-110036 and Japanese Patent Application Publication No. 2016-91716, for example.

A concave part is preferably nonlinear in order to vary the traveling direction of the light randomly. A convex part may have various shapes including a semicircular shape, a quadrangular pyramidal shape, and the like. Although not limited in particular, a ten point height of irregularities Rz based on JIS B601-1994 of the surface roughened part is preferably 10 to 100 μm, and more preferably 20 to 30 μm.

The ten point height of irregularities Rz of the light diffusion part LS is relatively higher than those of the bottom surface 70a, the center part to the lower end part of the long side surface 70b, and the short side surface 70c here. Moreover, the surface roughening ratio (surface area ratio) of the light diffusion part LS is relatively higher than those of the bottom surface 70a, the center part to the lower end part of the long side surface 70b, and the short side surface 70c here. The surface roughening ratio is expressed by the ratio (surface area/area) of the surface area formed by the surface shape to the area of a designated region of a sample.

Note that the light diffusion part LS, which is the surface roughened part here, may be other than the surface roughened part in another embodiment. For example, the light diffusion part LS may be a colored part obtained by coloring (for example, blacking) the surface of the insulation film, or may be provided by attaching another member with a light diffusing property (such as a commercial laminate film, emboss film, or reflection material) with an adhesive or the like to the surface of the insulating film. In this case, the thickness of the bent part 72 after the other member is attached may be, for example, 110 to 200 μm. Thus, the flexure of the bent part 72 can be suppressed and the bent part 72 can be kept apart from the electrode body 20 suitably at the laser welding.

As illustrated in FIG. 3, the upper end of the bent part 72 exists above the upper end of the electrode body 20 (that is, on the sealing plate 14 side) in the height direction Z. The lower end of the bent part 72 (perforations N) exists below the upper end of the electrode body 20 here. However, for example, when the electrode body 20 is a laminate electrode body as disclosed in Japanese Patent Application Publication No. 2020-095836, the perforations N may exist above the upper end of the electrode body 20.

The inclination angle (bending angle) θ of the bent part 72 relative to the long side surface 70b may be about 1° to 90°, without particular limitations. In particular, the inclination angle θ is preferably 5° or more, more preferably 10° or more, furthermore 30° or more, and 45° or more. The inclination angle θ may be 60° or more. When the inclination angle θ is a predetermined value or more, the upper end part of the electrode body 20 can be widely covered with the bent parts 72. Thus, even if the laser passing occurs at the laser welding and the laser light enters the case main body 12 through the space between the case main body 12 and the sealing plate 14, the electrode body 20 can be protected from the laser light at the high level. Even if the laser light is reflected in the case main body 12 made of metal, the electrode body 20 can be protected from the reflected laser light.

The inclination angle θ is preferably less than 90° (acute angle). The inclination angle θ may be 80° or less and 75° or less. When the inclination angle θ is a predetermined value or less, even if the metal foreign substance gets mixed in the case main body 12 at the time of manufacture, the mixed metal foreign substance is easily trapped on the outer surface of the film body 70 or between the outer surface of the film body 70 and the inner surface of the long side wall 12b. In other words, rolling of the metal foreign substance, which has been mixed in the case main body 12, in the bent part 72 and mixing of the rolled metal foreign substance into the electrode body 20 through the space between the bent parts 72 facing each other in the short side direction X can be suppressed.

### Manufacturing Method for Power Storage Device

For example, the power storage device 100 as described above can be manufactured by a manufacturing method including (S1) a preparing step, (S2) an accommodating step, (S3) a laser welding step, and (S4) a liquid injection step in this order typically. However, the liquid injection step is not essential and can be omitted when, for example, a solid electrolyte is used instead of the nonaqueous electrolyte solution. Regarding the order of the accommodating step, the laser welding step, and the liquid injection step, for example, the liquid injection step may come first. The manufacturing method in the present embodiment may include a step other than the aforementioned steps at an optional stage appropriately. Each step is hereinafter described.

In (S1) the preparing step, the battery case 10 (case main body 12 and sealing plate 14), the electrode body 20, the nonaqueous electrolyte solution, and the film body 70 are prepared. The battery case 10, the electrode body 20, and the nonaqueous electrolyte solution are as described above. The sealing plate 14 of the battery case 10 is integrated with the electrode body 20 in advance here. That is to say, the positive electrode terminal 30 and the negative electrode terminal 40 are attached to the sealing plate 14 by a caulking process. The positive electrode current collecting member 50 is attached to the positive electrode current collecting part 22 of the electrode body 20, and the negative electrode current collecting member 60 is attached to the negative electrode current collecting part 24 of the electrode body 20. The positive electrode current collecting member 50 is joined by welding to the positive electrode terminal 30 and the negative electrode current collecting member 60 is joined by welding to the negative electrode terminal 40.

According to the present inventor's knowledge, a machining error may occur in each of the case main body 12 and the sealing plate 14 that are prepared in this step. For example, in the case main body 12, a deviation in plate thickness, stress bending at the formation of the opening 12h (at trim cutting), or the like may occur. Moreover, in the sealing plate 14, a deviation in plate thickness, stress bending at the cutting time, crushing and expanding when the positive electrode terminal 30 and the negative electrode terminal 40 are subjected to the caulking process, or the like may occur. Due to these machining errors, laser passing occurs easily in (S3) the laser welding step to be described below.

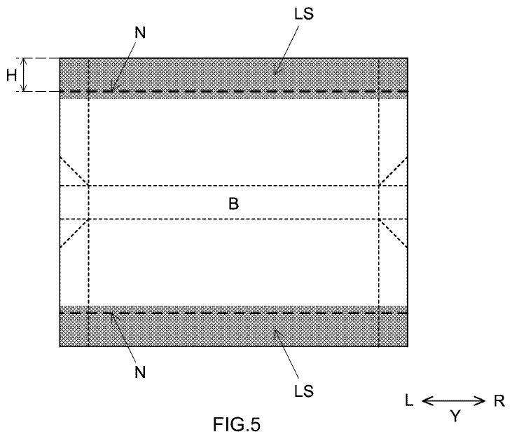

FIG. 5 is a schematic view of the insulation film that forms the film body 70 in FIG. 4. That is to say, FIG. 5 is a development view of the film body 70 in FIG. 4. The film body 70 in FIG. 4 is formed by the insulation film in FIG. 5. The insulation film in FIG. 5 can be prepared as follows, for example. That is to say, first, the insulation film is cut out of one band-shaped resin sheet into a shape (outer dimension) in accordance with the outer shape in FIG. 5. This outer dimension may be similar to the conventional one. Next, at a position of a dashed line in FIG. 5, ruled line processing (for example, groove processing, perforating processing, or the like) is performed for folding formation. At a position that corresponds to the upper end part in FIG. 5 and a position that corresponds to the lower end part in FIG. 5 to be disposed upward after being folded, half-cutting processing is performed linearly so as to form the perforations N. At the upper end part and the lower end part in FIG. 5, the height H from the perforations N to the upper end and the lower end is 3 mm here.

In a region of the insulation film from the perforations N to the upper end or the lower end is subjected to the roughening process, so that the surface roughened part (light diffusion part LS) is formed. The roughening process may be performed in a state of the band-shaped resin sheet or in a state before the aforementioned ruled line processing or half-cutting processing. By performing the surface processing on one insulation film to provide the surface roughened part, the manufacture becomes easier and the manufacturing cost can be reduced compared with the method using an additional member as disclosed in Japanese Patent Application Publication No. 2019-110036 and Japanese Patent Application Publication No. 2016-91716, for example. As described above, the insulation film (film body 70) as illustrated in FIG. 5 can be prepared.

Next, while a bottom surface part B of the insulation film faces the lower end part of the electrode body 20, the insulation film is folded along a dotted line so as to cover both end surfaces and the pair of wide surfaces 20f of the electrode body 20 with the film body 70. Then, the bent part 72 (light diffusion part LS) is bent toward the electrode body 20 at the predetermined inclination angle θ along the perforations N, so that the bent part 72 is formed.

Although not limited in particular, the inclination angle of the bent part 72 may be an acute angle (less than 90°), especially 45° or more and less than 90°. Thus, the bent part 72 has a posture extending from the long side surface 70b of the film body 70 toward the sealing plate 14 in the height direction Z of the case main body 12 and to the inside of the case main body 12 in the short side direction X. Thus, the insulation film in FIG. 5 can be formed on the film body 70 with the outer shape as illustrated in FIG. 4, and can be integrated with the electrode body 20.

In (S2) the accommodating step, the electrode body 20 and the film body 70 are accommodated in the case main body 12. Specifically, the electrode body 20 covered with the film body 70 and fixed to the sealing plate 14 is inserted into the internal space of the case main body 12 through the opening 12h. Thus, the film body 70 can be disposed between the case main body 12 and the electrode body 20. For example, the long side surfaces 70b of the film body 70 can be disposed between the long side walls 12b of the case main body 12 and the pair of wide surfaces 20f of the electrode body 20.

Note that when the electrode body 20 and the film body 70 are accommodated in the case main body 12, the sealing plate 14 may be in contact with the inner wall of the case main body 12, in which case an edge part of the sealing plate 14 or the case main body 12 may be ground to generate the metal foreign substance. In the art disclosed herein, however, even if the generated metal foreign substance falls in the case main body 12, the fallen metal substance can be trapped on the outer surface of the film body 70 or held between the outer surface of the film body 70 and the inner surface of the long side wall 12b so as to be kept away from the electrode body 20. Accordingly, the mixing of the metal foreign substance in the electrode body 20 and the occurrence of the short-circuiting of the electrode body 20 can be suppressed.

In (S3) the laser welding step, the sealing plate 14 is disposed in the opening 12h of the case main body 12. Then, the outer peripheral part of the sealing plate 14 is welded by laser to the inner peripheral part of the opening 12h of the case main body 12 along the entire circumference. The laser light irradiation condition (for example, output, beam diameter, processing speed (scanning speed of laser light), or the like) may be similar to the conventional condition. At the laser light irradiation, a space of about several tens of micrometers may be formed due to a machining error or the like between the outer peripheral edge of the sealing plate 14 and the inner peripheral edge of the opening 12h of the case main body 12. In the art disclosed herein, however, the light diffusion part LS is provided to at least the bent part 72. Thus, even if laser passing occurs at the laser welding and the laser light enters the case main body 12 through the space between the case main body 12 and the sealing plate 14, the laser light can be diffused by the light diffusion part LS. Accordingly, the beam density of the laser light can be reduced and the heat of the laser light is diffused; therefore, the film body 70 is melted less easily. As a result, the laser light does not easily fall on the electrode body 20, and accordingly, the scorching of the electrode body 20 and the internal short-circuiting can be suppressed.

In addition, when the bent part 72 is apart from the upper end part of the electrode body 20, the conduction of the heat of the laser to the electrode body 20 can be prevented at the high level. Moreover, in the art disclosed herein, even if the high-temperature molten metal is generated at the laser welding as the microparticles (so-called spattering) from the welded part and falls in the case main body 12, the fallen molten metal can be kept away from the electrode body 20. Accordingly, only with the film body 70, the occurrence of the scorching of the electrode body 20 due to the laser passing and the occurrence of the short-circuiting due to the mixing of the molten metal can be suppressed at the same time without the necessity of using the additional member as disclosed in Japanese Patent Application Publication No. 2019-110036 and Japanese Patent Application Publication No. 2016-91716, for example.

The art disclosed herein has a particularly high effect when there is a space larger than the beam diameter (for example, a space of 70 μm or more, or 90 μm or more) between the opening 12h of the case main body 12 and the sealing plate 14. The art disclosed herein also has a particularly high effect when the laser light with high output (for example, laser light with 1000 W or more) is used in order to shorten the time required for the laser welding.

In (S4) the liquid injection step, the nonaqueous electrolyte solution is injected into the case main body 12 through a liquid injection hole, which is not shown, provided to the sealing plate 14. Then, the liquid injection hole is sealed with a liquid injection plug or the like. Thus, the power storage device 100 as illustrated in FIG. 1 to FIG. 3 can be manufactured.

Note that after the laser welding step (for example, in the state of the power storage device 100 after this step), the inclination angle θ may decrease due to the change over time from the laser welding time, for example, or may increase from the laser welding time due to the weight of the nonaqueous electrolyte solution or the like.

### Application of Power Storage Device

The power storage device 100 is usable in various applications, and in particular, can be suitably used as a large (high-capacity) power storage device in which the battery case 10 is large and the energy density is high. The suitable applications include, for example, a motive power source (power source for vehicle driving) for a motor mounted on a vehicle such as a plug-in hybrid electric vehicle (PHEV), a hybrid electric vehicle (HEV), or a battery electric vehicle (BEV).

The specific examples of the present disclosure have been described above in detail; however, these embodiments are examples and will not limit the scope of claims. The techniques described in the scope of claims include those in which the specific examples exemplified above are variously modified and changed.

As described above, the following items are given as specific aspects of the art disclosed herein.

Item 1: The manufacturing method for a power storage device including: the case main body made of metal and including the bottom wall with a rectangular shape, the pair of long side walls extending from the long sides of the bottom wall and facing each other, the pair of short side walls extending from the short sides of the bottom wall and facing each other, and the opening facing the bottom wall; the sealing plate made of metal, disposed in the opening of the case main body, and having the outer peripheral part thereof welded by laser to the inner peripheral part of the opening of the case main body; the electrode body accommodated in the case main body and including the pair of wide surfaces facing the long side walls; and the film body with the insulating property that exists between the electrode body and the case main body, in which the film body includes the pair of long side surfaces existing between the pair of long side walls of the case main body and the pair of wide surfaces of the electrode body and extending along the long side walls, and the bent parts extending from the pair of long side surfaces toward the sealing plate and bent so as to get close to the electrode body, and the light diffusion part that diffuses the laser light is provided to at least the bent part, the manufacturing method for a power storage device, including: the preparing step of preparing the film body; the accommodating step of accommodating the electrode body and the film body in the opening of the case main body; and the laser welding step of disposing the sealing plate in the opening of the case main body and welding the outer peripheral part of the sealing plate to the case main body by laser.
Item 2: The manufacturing method for a power storage device according to Item 1, in which in the preparing step, the insulation film is prepared as the film body and the light diffusion part is formed by performing the roughening process on the surface of the insulation film.
Item 3: The manufacturing method for a power storage device according to Item 1 or 2, in which in the preparing step, the inclination angle of the bent part relative to the long side surface is 45° or more and less than 90°.
Item 4: The power storage device including: the case main body made of metal and including the bottom wall with a rectangular shape, the pair of long side walls extending from the long sides of the bottom wall and facing each other, the pair of short side walls extending from the short sides of the bottom wall and facing each other, and the opening facing the bottom wall; the sealing plate made of metal, disposed in the opening of the case main body, and having the outer peripheral part thereof welded by laser to the inner peripheral part of the opening of the case main body; the electrode body accommodated in the case main body and including the pair of wide surfaces facing the long side walls; and the film body with the insulating property that exists between the electrode body and the case main body, in which the film body includes the pair of long side surfaces existing between the pair of long side walls of the case main body and the pair of wide surfaces of the electrode body and extending along the long side walls, and the bent parts extending from the pair of long side surfaces toward the sealing plate and bent so as to get close to the electrode body, and the light diffusion part that diffuses the laser light is provided to at least the bent part.
Item 5: The power storage device according to Item 4, in which the film body is formed by the insulation film, and the light diffusion part is the surface roughened part formed by performing the roughening process on the surface of the insulation film.
Item 6: The power storage device according to Item 4 or 5, in which the inclination angle of the bent part relative to the long side surface is 45° or more and less than 90°.

Although the preferred embodiment of the present application has been described thus far, the foregoing embodiment is only illustrative, and the present application may be embodied in various other forms. The present application may be practiced based on the disclosure of this specification and technical common knowledge in the related field. The techniques described in the claims include various changes and modifications made to the embodiment illustrated above. Any or some of the technical features of the foregoing embodiment, for example, may be replaced with any or some of the technical features of variations of the foregoing embodiment. Any or some of the technical features of the variations may be added to the technical features of the foregoing embodiment. Unless described as being essential, the technical feature(s) may be optional.

### REFERENCE SIGNS LIST

10 Battery case
12 Case main body
12b Long side wall
12h Opening
14 Sealing plate
20 Electrode body
20f Wide surface
70 Film body
70b Long side surface
72 Bent part
100 Power storage device

What is claimed is:

1. A manufacturing method for a power storage device comprising:
a case main body made of metal and including a bottom wall with a rectangular shape, a pair of long side walls extending from long sides of the bottom wall and facing each other, a pair of short side walls extending from short sides of the bottom wall and facing each other, and an opening facing the bottom wall;
a sealing plate made of metal, disposed in the opening of the case main body, and having an outer peripheral part thereof welded by laser to an inner peripheral part of the opening of the case main body;
an electrode body accommodated in the case main body and including a pair of wide surfaces facing the long side walls; and
a film body with an insulating property that exists between the electrode body and the case main body, wherein
the film body includes a pair of long side surfaces existing between the pair of long side walls of the case main body and the pair of wide surfaces of the electrode body and extending along the long side walls, and bent parts extending from the pair of long side surfaces toward the sealing plate and bent so as to get close to the electrode body, and
a light diffusion part that diffuses laser light is provided to at least the bent part,
the manufacturing method for a power storage device, comprising:
a preparing step of preparing the film body;
an accommodating step of accommodating the electrode body and the film body in the case main body; and
a laser welding step of disposing the sealing plate in the opening of the case main body and welding the outer peripheral part of the sealing plate to the case main body by laser.

2. The manufacturing method for a power storage device according to claim 1, wherein in the preparing step, an insulation film is prepared as the film body and the light diffusion part is formed by performing a roughening process on a surface of the insulation film.

3. The manufacturing method for a power storage device according to claim 1, wherein in the preparing step, an inclination angle of the bent part relative to the long side surface is 45° or more and less than 90°.

4. A power storage device comprising:
a case main body made of metal and including a bottom wall with a rectangular shape, a pair of long side walls extending from long sides of the bottom wall and facing each other, a pair of short side walls extending from short sides of the bottom wall and facing each other, and an opening facing the bottom wall;
a sealing plate made of metal, disposed in the opening of the case main body, and having an outer peripheral part thereof welded by laser to an inner peripheral part of the opening of the case main body;
an electrode body accommodated in the case main body and including a pair of wide surfaces facing the long side walls; and
a film body with an insulating property that exists between the electrode body and the case main body, wherein
the film body includes a pair of long side surfaces existing between the pair of long side walls of the case main body and the pair of wide surfaces of the electrode body and extending along the long side walls, and bent parts extending from the pair of long side surfaces toward the sealing plate and bent so as to get close to the electrode body, and
a light diffusion part that diffuses laser light is provided to at least the bent part.

5. The power storage device according to claim 4, wherein
the film body is formed by an insulation film, and
the light diffusion part is a surface roughened part formed by performing a roughening process on a surface of the insulation film.

6. The power storage device according to claim 4, wherein an inclination angle of the bent part relative to the long side surface is 45° or more and less than 90°.
